(19) United States
(12) Patent Application Publication
(10) Pub. No.: US 2026/0238771 A1
(43) Pub. Date: Aug. 13, 2026

(54) MOST PROBABLE MODES LIST

(71) Applicant: InterDigital CE Patent Holdings, SAS, Paris (FR)

(72) Inventors: Kevin Reuzé, Rennes (FR); Karam Naser, Mouazé (FR); Ya Chen, Rennes (FR); Thierry Dumas, Rennes (FR)

(73) Assignee: InterDigital CE Patent Holdings, SAS, Paris (FR)

(21) Appl. No.: 19/471,650

(22) PCT Filed: Mar. 25, 2024
(86) PCT No.: PCT/EP2024/057933

§ 371 Date: Oct. 1, 2025

(30) Foreign Application Priority Data
Apr. 7, 2023 (EP) 23305512.8

(51) Int. Cl. H04N 19/11; H04N 19/176; H04N 19/593

(52) U.S. Cl. CPC H04N 19/11; H04N 19/176; H04N 19/593

(57) ABSTRACT

Systems, devices, and methods are described herein for generating and reordering of a most probable mode list for intra prediction. For example, a device for video decoding and/or video encoding may determine an intra prediction mode associated with a neighboring block, e.g., based on a template-based intra mode derivation (TIMD) and/or a decoder side intra mode derivation (DIMD). The device may determine whether the intra prediction mode associated with the neighboring block is the same as a candidate mode on a most probable mode (MPM) list. Based on a determination that the intra prediction mode is the same as the candidate mode, the device may adjust a weight associated with the candidate mode. Based on the adjusted weight associated with the candidate mode, the device may reorder the MPM list based. The device may encode/decode the current block based on the MPM list.

### CROSS-REFERENCE TO RELATED APPLICATIONS

This application claims the benefit of European Provisional Patent Application No. 23305512.8 filed Apr. 7, 2023, the contents of which are incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, devices, and methods are described herein for generating and/or reordering of a most probable mode list for intra prediction. For example, an apparatus and/or a device for video encoding and/or decoding, such as a video decoder and/or a video decoder, may include a processor that is configured to perform one or more procedures described herein. The apparatus may determine an intra prediction mode associated with a neighboring block. The apparatus may determine a neighboring block based on a current block. The apparatus may determine whether the intra prediction mode (e.g., a first intra prediction mode) associated with the neighboring block is the same as a candidate mode on a most probable mode (MPM) list. The MPM list may be associated with the current block. In examples, the apparatus may determine the intra prediction mode associated with the neighboring block based on a template-based intra mode derivation (TIMD). In examples, the apparatus may determine the intra prediction mode associated with the neighboring block based on a decoder side intra mode derivation (DIMD).

Based on a determination that the intra prediction mode associated with the neighboring block is the same as the candidate mode on the MPM list, the apparatus may adjust a weight (e.g., a first weight) associated with the candidate mode. Based on the adjusted weight associated with the candidate mode, the apparatus may reorder the MPM list. The apparatus may encode/decode the current block based on the MPM list. In examples, the apparatus for video decoding may decode the current block based on the MPM list. In examples, the apparatus for video encoding may encode the current block based on the MPM list.

The apparatus may determine another intra prediction mode (e.g., a second intra prediction mode) associated with the neighboring block. In examples, the apparatus may determine a second intra prediction mode associated with the neighboring block based on the TIMD. In examples, the apparatus may determine a second intra prediction mode associated with the neighboring block based on the DIMD.

If the apparatus determines a second intra prediction mode associated with the neighboring block based on the TIMD, the apparatus may obtain a template cost associated with the intra prediction mode. For example, the apparatus may obtain a first template cost associated with the first intra prediction mode and may obtain a second template cost associated with the second intra prediction mode. The apparatus may determine a second weight associated with a second candidate mode. The second candidate mode may correspond to the second intra prediction mode. The first weight described herein may be determined based on the first template cost. The second weight described herein may be determined based on the second template cost. As described herein, the apparatus may adjust the second weight associated with the second candidate mode. The apparatus may reorder the MPM list based on the second adjusted weight associated with the second candidate mode.

If the apparatus determines a second intra prediction mode associated with the neighboring block based on the DIMD, the apparatus may obtain a histogram value associated with the intra prediction mode. For example, the apparatus may obtain a first histogram value associated with the first intra prediction mode and may obtain a second histogram value associated with the second intra prediction mode. The apparatus may determine a second weight associated with a second candidate mode. The second candidate mode may correspond to the second intra prediction mode. The first weight described herein may be determined based on the first histogram value. The second weight described herein may be determined based on the second histogram value. As described herein, the apparatus may adjust the second weight associated with the second candidate mode. The apparatus may reorder the MPM list based on the second adjusted weight associated with the second candidate mode.

In examples, the apparatus may determine a second intra prediction mode associated with a second neighboring block, e.g., based on TIMD or DIMD as described herein. The device may determine whether the second intra prediction mode associated with the second neighboring block is the same as the second candidate mode on the MPM list. Based on a determination that the second intra prediction mode associated with the second neighboring block is the same as the second candidate mode on the MPM list, the device may adjust a second weight associated with the second candidate mode. The device may reorder the MPM list based on the second adjusted weight associated with the second candidate mode. As described herein, the apparatus may encode/decode the current block based on the MPM list. In examples, the apparatus for video decoding may decode the current block based on the MPM list. In examples, the apparatus for video encoding may encode the current block based on the MPM list.

A method for video decoding and/or a method for video encoding may be configured to perform one or more procedures described herein (e.g., one or more procedures performed by the apparatus for video encoding/video decoding. In examples, a computer readable medium may include instructions for video encoding and/or video decoding. For example, the instructions may configure a processor to perform one or more procedures described herein. In examples a computer program product for video encoding and/or video decoding may include program code instructions for implementing one or more procedures described herein. The computer program product may be stored on a transitory computer readable medium and/or a non-transitory computer readable medium. In examples, video data may include information representative of a video content encoded or a supplemental enhancement information message transmitted by one or more procedures described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example block-based video encoder.

FIG. 3 is a diagram showing an example video decoder.

FIG. 4 is a diagram showing an example of a system in which various aspects and examples may be implemented.

FIG. 5 shows example decoder side intra mode derivation (DIMD) regions used to infer the location dependency of DIMD modes.

FIG. 6 shows an example spatial geometric partition mode (SGPM) and related signaling.

FIG. 7 shows an example geometric partition mode (GPM) template(s).

FIG. 8 shows an example blending area in GPM.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

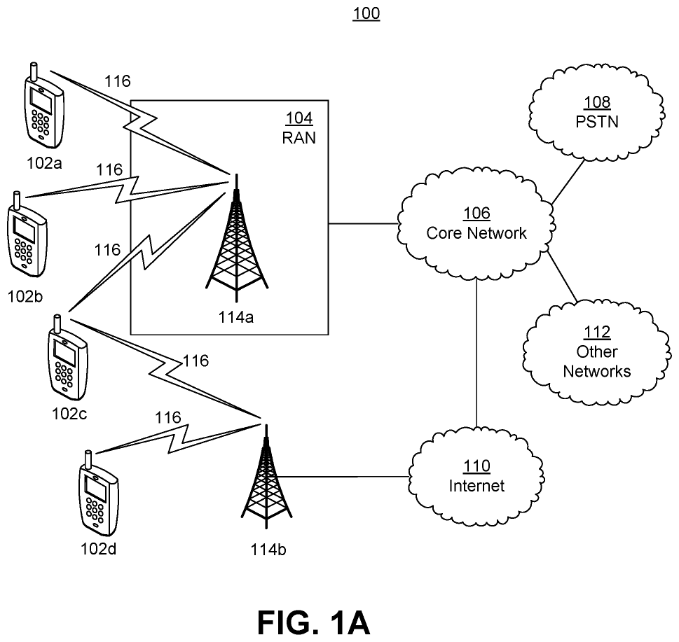

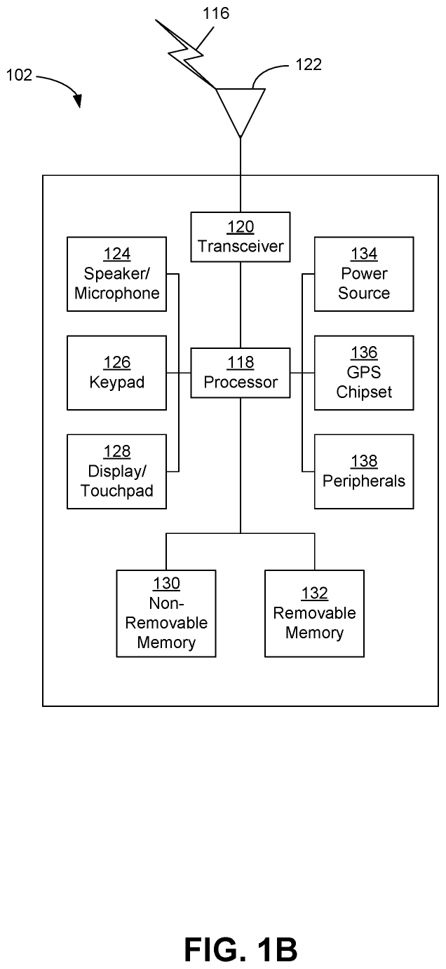

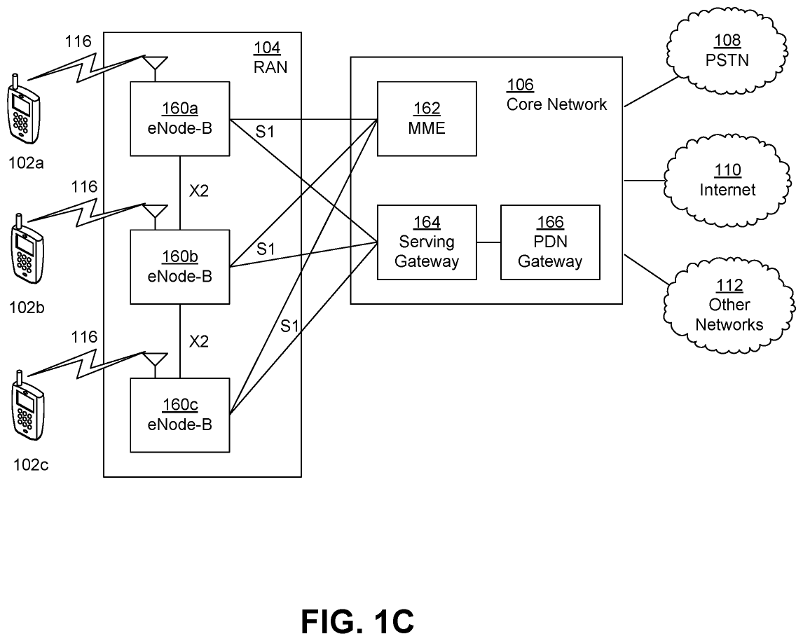

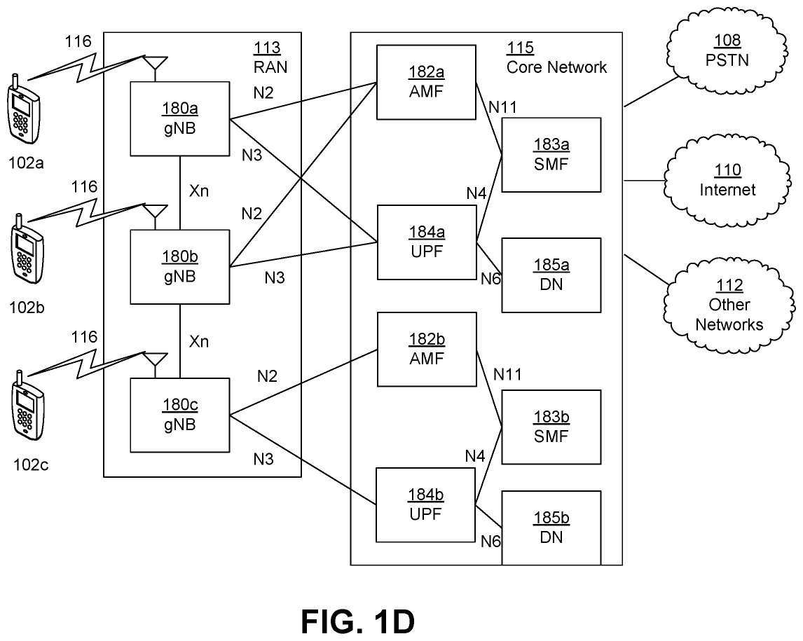

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be a test equipment. Direct RF coupling and/or wireless communications via RF circuitry (e.g., which may include one or more antennas) may be used by the emulation devices to transmit and/or receive data.

This application describes a variety of aspects, including tools, features, examples or embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

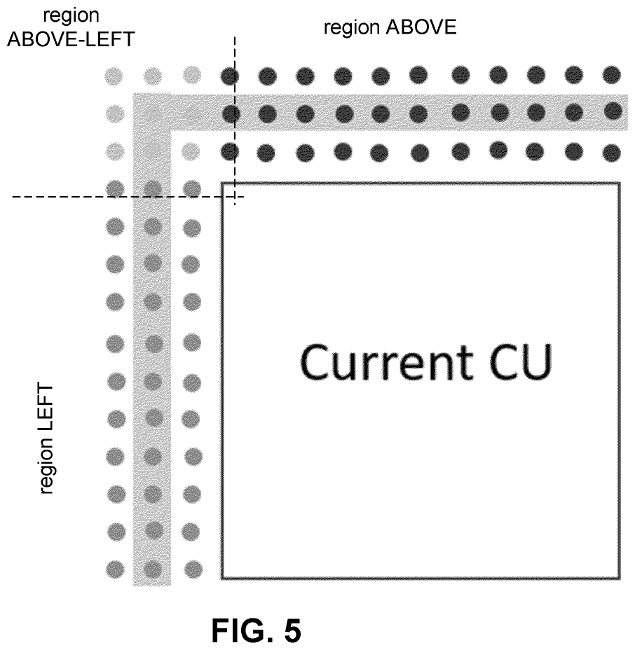

The aspects described and contemplated in this application may be implemented in many different forms. FIGS. 5-8 described herein may provide some embodiments, but other embodiments are contemplated. The discussion of FIGS. 5-8 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

The terms HDR (high dynamic range) and SDR (standard dynamic range) may be used in this disclosure. Those terms often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.”

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

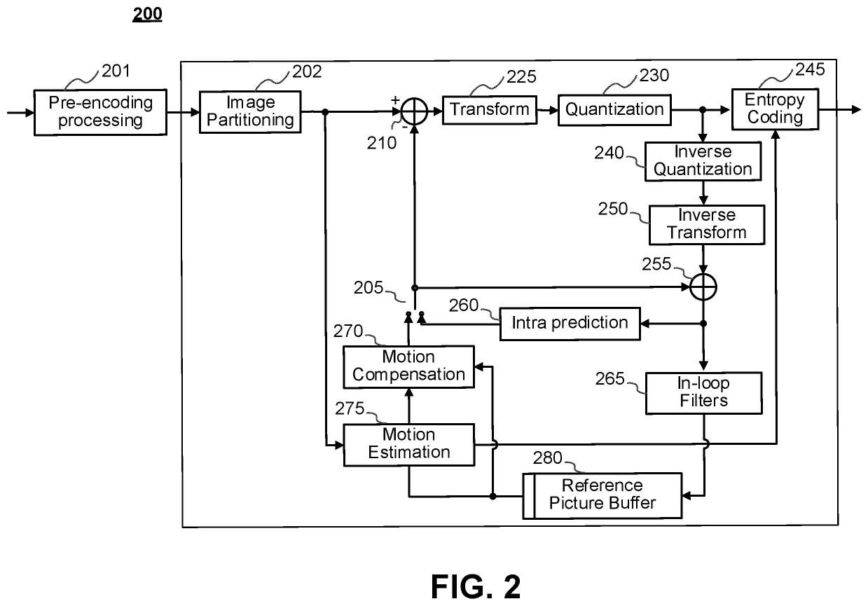

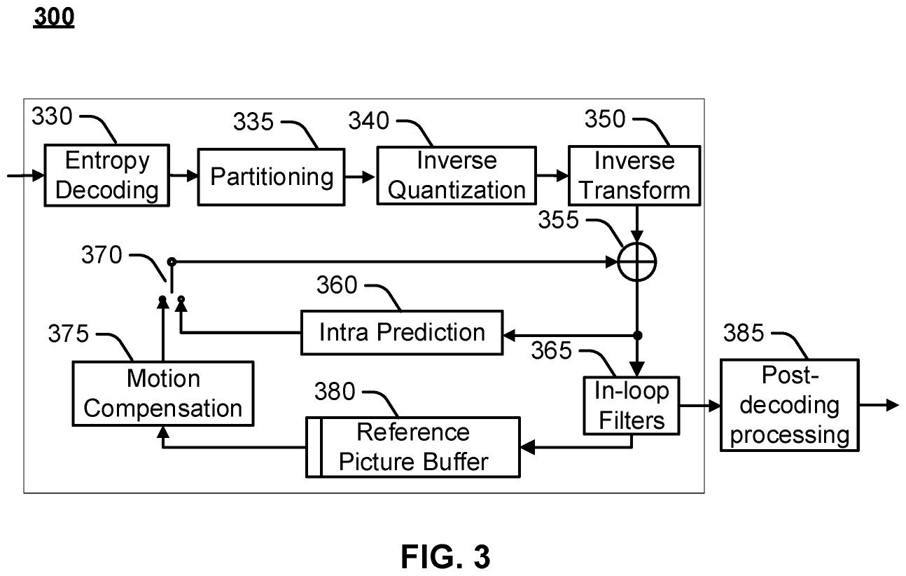

Various methods and other aspects described in this application may be used to modify modules, for example, intra prediction and/or decoding modules (260, 330), of a video encoder 200 and decoder 300 as shown in FIG. 2 and FIG. 3. Moreover, the subject matter disclosed herein presents aspects that are not limited to VVC or HEVC, and may be applied, for example, to any type, format or version of video coding, whether described in a standard or a recommendation, whether pre-existing or future-developed, and extensions of any such standards and recommendations (e.g., including VVC and HEVC). Unless indicated otherwise, or technically precluded, the aspects described in this application may be used individually or in combination.

Various numeric values are used in examples described in the present application. These and other specific values are for purposes of describing examples and the aspects described are not limited to these specific values.

FIG. 2 illustrates a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and may be attached to video data (e.g., the bitstream).

In the encoder 200, a picture is encoded by the encoder elements as described below. The picture to be encoded is partitioned (202) and processed in units of, for example, coding units (Cus). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, e.g., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 illustrates a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (e.g., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YcbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

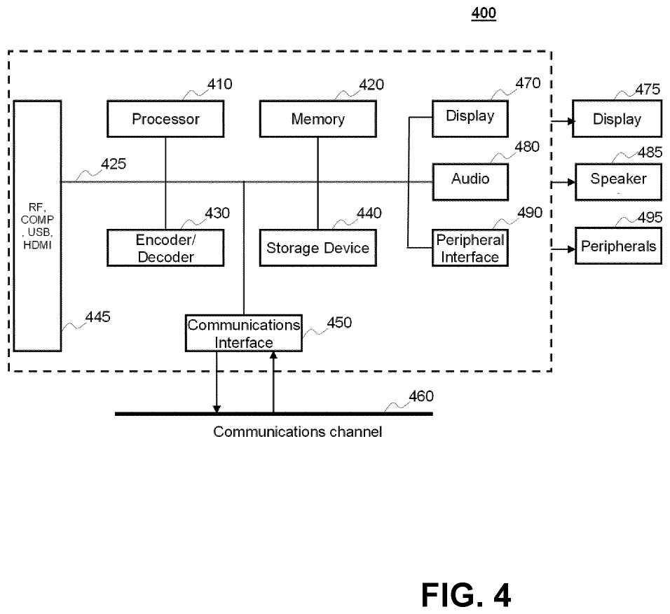

FIG. 4 illustrates a diagram showing an example of a system in which various aspects and embodiments described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple lcs, and/or discrete components. For example, in at least one example, the processing and encoder/decoder elements of system 400 are distributed across multiple Ics and/or discrete components. In various embodiments, the system 400 is communicatively coupled to one or more other systems, or other electronic devices, via, for example, a communications bus or through dedicated input and/or output ports. In various embodiments, the system 400 is configured to implement one or more of the aspects described in this document.

The system 400 may include at least one processor 410 configured to execute instructions loaded therein for implementing, for example, the various aspects described in this document. Processor 410 may include embedded memory, input output interface, and various other circuitries as known in the art. The system 400 includes at least one memory 420 (e.g., a volatile memory device, and/or a non-volatile memory device). System 400 may include a storage device 440, which may include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 may include an internal storage device, an attached storage device (including detachable and non-detachable storage devices), and/or a network accessible storage device, as non-limiting examples.

System 400 may include an encoder/decoder module 430 configured, for example, to process data to provide an encoded video or decoded video, and the encoder/decoder module 430 may include its own processor and memory. The encoder/decoder module 430 represents module(s) that may be included in a device to perform the encoding and/or decoding functions. As is known, a device may include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this application may be stored in storage device 440 and subsequently loaded onto memory 420 for execution by processor 410. In accordance with various embodiments, one or more of processor 410, memory 420, storage device 440, and encoder/decoder module 430 may store one or more of various items during the performance of the processes described in this document. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 may be used to store instructions and to provide working memory for processing that is needed during encoding or decoding. In other embodiments, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WC (Versatile Video Coding, a new standard being developed by JVET, the Joint Video Experts Team).

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals may include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface Ics or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 may include a communication interface 450 that enables communication with other devices via communication channel 460. The communication interface 450 can include, but is not limited to, a transceiver configured to transmit and to receive data over communication channel 460. The communication interface 450 may include, but is not limited to, a modem or network card and the communication channel 460 may be implemented, for example, within a wired and/or a wireless medium.

Data may be streamed, or otherwise provided, to the system 400, in various embodiments, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of the one or more embodiments may be typically connected to an access point or router that provides access to external networks including the Internet for allowing streaming applications and other over-the-top communications. Other embodiments may provide streamed data to the system 400 using a set-top box that delivers the data over the HDMI connection of the input block 445. Still other embodiments may provide streamed data to the system 400 using the RF connection of the input block 445. As indicated above, various embodiments may provide data in a non-streaming manner. Additionally and/or alternatively, various embodiments may use one or more wireless networks other than Wi-Fi, for example a cellular network or a Bluetooth network.

The system 400 may provide an output signal to various output devices, including a display 475, speakers 485, and other peripheral devices 495. The display 475 of various embodiments may include one or more of a touchscreen display, an organic light-emitting diode (OLED) display, a curved display, a foldable display, and/or the like. The display 475 may be for a television, a tablet, a laptop, a cell phone (mobile phone), or other device. The display 475 may also be integrated with other components (for example, as in a smart phone), or separate (for example, an external monitor for a laptop). The other peripheral devices 495 may include, in various examples of embodiments, one or more of a stand-alone digital video disc (or digital versatile disc) (DVR, for both terms), a disk player, a stereo system, and/or a lighting system. Various embodiments may use one or more peripheral devices 495 that provide a function based on the output of the system 400. For example, a disk player may perform the function of playing the output of the system 400.

In various embodiments, control signals may be communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Additionally and/or alternatively, the output devices may be connected to system 400 using the communications channel 460 via the communications interface 450. The display 475 and speakers 485 may be integrated in a single unit with the other components of system 400 in an electronic device such as, for example, a television. In various embodiments, the display interface 470 may include a display driver, such as, for example, a timing controller (T Con) chip.

The display 475 and speakers 485 may additionally and/or alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, may encompass all or part of the processes performed, for example, on a received encoded sequence in order to produce a final output suitable for display. In various embodiments, such processes may include one or more of the processes typically performed by a decoder, for example, entropy decoding, inverse quantization, inverse transformation, and differential decoding. In various embodiments, such processes also, or alternatively, may include processes performed by a decoder of various implementations described in this application, for example, obtaining an intra prediction mode associated with a neighboring block of the current block based on analyzing a template of the neighboring block, adding the obtained intra prediction mode associated with the neighboring block to a most probable mode list of the current block, and decoding the current block based on the most probable mode list, etc.

As further embodiments, in one example “decoding” may refer only to entropy decoding. In another embodiment “decoding” may refer only to differential decoding, and in another embodiment “decoding” refers to a combination of entropy decoding and differential decoding. Whether the phrase “decoding process” is intended to refer specifically to a subset of operations or generally to the broader decoding process may be clear based on the context of the specific descriptions and may be believed to be well understood by those skilled in the art.

Various implementations may involve encoding. In an analogous way to the above discussion about “decoding”, “encoding” as used in this application may encompass all or part of the processes performed, for example, on an input video sequence in order to produce an encoded video data, such as an encoded bitstream. In various embodiments, such processes may include one or more of the processes typically performed by an encoder, for example, partitioning, differential encoding, transformation, quantization, and entropy encoding. In various embodiments, such processes also, or alternatively, may include processes performed by an encoder of various implementations described in this application, for example, obtaining an intra prediction mode associated with a neighboring block of the current block based on analyzing a template of the neighboring block, adding the obtained intra prediction mode associated with the neighboring block to a most probable mode list of the current block, and encoding the current block based on the most probable mode list, etc.

As further examples, in one embodiment “encoding” may refer only to entropy encoding. In another embodiment “encoding” may refer only to differential encoding, and in another embodiment “encoding” may refer to a combination of differential encoding and entropy encoding. Whether the phrase “encoding process” is intended to refer specifically to a subset of operations or generally to the broader encoding process may be clear based on the context of the specific descriptions and may be believed to be well understood by those skilled in the art.

Note that syntax elements as used herein may be descriptive terms. As such, the syntax elements may not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to rate distortion optimization. In particular, during the encoding process, the balance or trade-off between the rate and distortion may usually considered, often given the constraints of computational complexity. The rate distortion optimization may usually formulated as minimizing a rate distortion function, which is a weighted sum of the rate and of the distortion. There may be one or more different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches may also be used, such as by using an approximated distortion for only some of the possible encoding options, and a complete distortion for other encoding options. Other approaches may only evaluate a subset of the possible encoding options. More generally, many approaches may employ any of a variety of techniques to perform the optimization, but the optimization may not be necessarily a complete evaluation of both the coding cost and related distortion.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment,” “an embodiment,” “an example,” “one implementation” or “an implementation,” as well as other variations thereof, means that a particular feature, structure, characteristic, and so forth described in connection with the embodiment is included in at least one embodiment. Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information. Determining the information may include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving may be, as with “accessing”, intended to be a broad term. Receiving the information may include one or more of, for example, accessing the information, or retrieving the information (for example, from memory). Further, “receiving” may typically be involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder may transmit (e.g., explicit signaling) a particular parameter to the decoder so that the decoder can use the same particular parameter. Conversely, if the decoder already has the particular parameter as well as others, then signaling may be used without transmitting (e.g., implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Many examples are described herein. Features of examples may be provided alone or in any combination, across various claim categories and types. Further, examples may include one or more of the features, devices, or aspects described herein, alone or in any combination, across various claim categories and types.

A most probable mode (MPM) list-based signaling approach may be used for video encoding/decoding. A primary MPM (PMPM) and a secondary MPM (SMPM) may be generated. The primary MPM (PMPM) may include six (6) entries. The secondary MPM (SMPM) may include sixteen (16) entries. A generic MPM list may be built, for example, by sequentially adding candidate intra prediction mode indices, e.g., from the one most likely being the selected intra prediction mode for predicting the current CU to the least likely one.

The first entry in the MPM list may be the Planar mode. The remaining entries may be obtained from the intra modes of the above (A), left (L), below-left (BL), above-right (AR), and above-left (AL) neighboring blocks in sequential order. The order to insert intra modes of neighboring blocks into an MPM list may be built starting from the above neighbor intra mode. The order to insert above and left neighboring intra modes may be swapped, for example, if a rectangular block is horizontally oriented (e.g., if the width is greater than the height).

Decoder side intra mode derivation (DIMD) may be used to generate candidate mode(s) for an MPM list. DIMD may be used to generate directional modes (e.g., two directional modes). The first and second modes may be added to the MPM list. The directional modes with added offsets (e.g., ±1, ±2, ±3, ±4) from the first two available directional modes of neighboring blocks (e.g., “derived modes” for simplification) and (e.g., additional) predefined default modes may be included. The default mode list may be defined as {DC_IDX/1, VER_IDX/50, HOR_IDX/18, VER_IDX-4, VER_IDX+4, 14, 22, 42, 58, 10, 26, 38, 62, 6, 30, 34, 66, 2, 48, 52, 16}.

Multiple reference line (MRL) may not provide additional coding gain when the intra prediction mode is the planar mode, since the planar mode may be (e.g., typically) used for smooth areas. In some examples, if mrl_index is not 0, the planar mode may be excluded as the first MPM entry and/or the entries filled in SMPM may not be used.

A generic list of MPMs may not contain (e.g., may be guaranteed not to contain) two identical intra prediction mode indices. For example, the slots of indices 0 to i−1 included in the generic list of MPMs may have already been filled. If the current candidate intra prediction mode index already exists in the current generic list of MPMs, the candidate may be skipped, and the next candidate intra prediction mode may be inserted at the slot of index i. If the current intra prediction mode index does not exist in the generic list of MPMs, the current intra prediction mode index may be inserted at the slot of index i and the next candidate intra prediction mode may be inserted at the slot of index i+1.

If DIMD is applied, intra modes (e.g., two intra modes) may be derived from the reconstructed neighbor samples, and those predictors (e.g., two predictors) may be combined with the planar mode predictor with the weights derived from the gradients (Gx, Gy) computed with reconstructed neighbor samples. The division operations in weight derivation may be performed utilizing a lookup table (LUT) (e.g., the same LUT based integerization scheme used by the CCLM mode). In examples, the division operation in the orientation calculation:

$$Orient = {G}_{y} / {G}_{x}$$

may be computed by the following LUT-based scheme:

$$x = Floor ( Log 2 ( G x ) ) \\ normDiff = ( ( Gx << 4 ) >> x ) \& 15 \\ x += ( normDiff != 0 ) ? 1 : 0 \\ Orient = ( Gy * ( DivSigTable [ normDiff ] \vert 8 ) + ( 1 << ( x - 1 ) ) ) >> x$$

Where:

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes may be included into the primary list of intra MPMs, so the DIMD process may be performed before the MPM list is constructed. The primary derived intra mode of a DIMD block may be stored with a block and may be used for MPM list construction of the neighboring blocks.

Location dependent DIMD may be performed. Non-uniform, sample-based weights may be used to blend the DIMD predictors. Sampling-based blending, and the weights to use for a given predictor, may be inferred during the DIMD derivation. In deriving a DIMD mode, whether the derivation of the mode is mostly influenced by the template region above or on the left of the current block may be determined. If a DIMD mode is mostly derived from samples above the current block, higher weights may be used for samples closer to the above portion of the block when blending the corresponding predictor.

To determine whether specific samples in the template contribute to inferring specific DIMD modes, separate regions may be considered within the DIMD template, as in FIG. 5. The gradient computation may be performed separately for samples in each region, resulting in three histograms, H_{above}, H_{left} and H_{aboveLeft}, respectively. For a directional mode m, H_{above}[m] may represent the cumulative magnitude of the samples in the region ABOVE at direction m. The template area may be extended by a sample on the top-left and a sample on the bottom-right, with respect to other example DIMD.

The full histogram of gradients for the whole template can be computed as the sum of the separate histograms. The two directional modes with largest and second-largest cumulative magnitude in the histogram may be selected as main and secondary DIMD modes, dimdMode₀ and dimdMode₁, respectively.

Additionally, the histograms H_{above} and H_{left} can be used to determine whether dimdMode₀ and/or dimdMode₁ depend on a specific template region ABOVE or LEFT. For example, the location-dependency of dimdModeᵢ, denoted as locDepᵢ, can be defined as:

If: (H_{above}[dimdModeᵢ]>2H_{left}[dimdModeᵢ]), then:
locDepᵢ=1, e.g., dimdModeᵢ may depend on region ABOVE.

Else if: (H_{left}[dimdModeᵢ]>2H_{above}[dimdModeᵢ]), then:
locDepᵢ=2, e.g., dimdModeᵢ may depend on region LEFT.

Else:
locDepᵢ=0, e.g., dimdModeᵢ may not be location-dependent.

Intra prediction fusion may use multiple predictors generated from different modes/reference lines. In some examples, intra prediction fusion may be performed on prediction blocks. Multiple intra predictors may be generated and then fused, for example, by weighted averaging. The predictors to be used in the fusion process may be obtained based on derived intra prediction modes.

For angular intra prediction modes, including the single mode case of template-based intra mode derivation (TIMD) and DIMD, intra prediction mode(s) may be derived by weighting intra predictions obtained from multiple reference lines represented as p_{fusion}=w₀pₗᵢₙₑ+w₁pₗᵢₙₑ₊₁, where pₗᵢₙₑ may be the intra prediction from the default reference line, and pₗᵢₙₑ₊₁ may be the prediction from the line above the default reference line. The weights may be set as w₀=3/4 and w₁=1/4.

For TIMD mode with blending, pₗᵢₙₑ may be used for the first mode (w₀=1, w₁=0), and pₗᵢₙₑ₊₁ may be used for the second mode (w₀=0, w₁=1). For DIMD mode with blending, the number of predictors selected for a weighted average may be increased from 3 to 6.

In some examples, intra prediction fusion may be performed on reference lines. Two reference lines (referred to as rₗᵢₙₑ and rₗᵢₙₑ₊₁) may be used for intra prediction fusion. DeltaInt of the corresponding intra prediction angle may be considered in the fusion process. The value(s) in the fused reference line (r_{fusion}[i]) is derived from:

$${r}_{fusion} [ i ] = ( 3 * {r}_{l i n e} [ i ] + {r}_{l i n e + 1} [ i + DeltaInt ] ) >> 2$$

Intra prediction fusion may be applied to luma blocks, for example, if/when angular intra mode has a non-integer slope (e.g., required reference samples interpolation) and the block size is greater than 16. Intra prediction fusion may be used with MRL. In some examples, intra prediction fusion may not be applied for intra sub partition (ISP) coded blocks. In examples, position dependent intra prediction combination (PDPC) may be used for the intra prediction mode using the reference line closest to the current block.

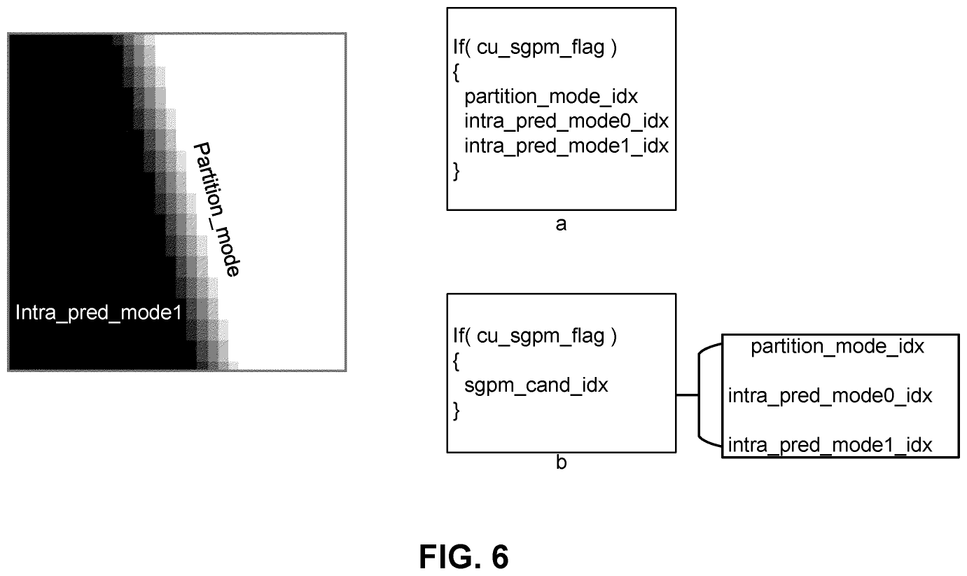

FIG. 6 illustrates example spatial GPM (SPGM) candidates. SGPM may be an intra mode that may resemble the inter coding tool of GPM. The two prediction parts may be generated from an intra predicted process. In SGPM, a candidate list may be built with each entry containing a (e.g., one) partition split and two intra prediction modes, as illustrated in FIG. 6. One or more (e.g., 26) partition modes and one or more (e.g., three) intra prediction modes may be used to form the combinations. The length of the candidate list may be set to a predetermined number (e.g., 16). The selected candidate index may be signaled.

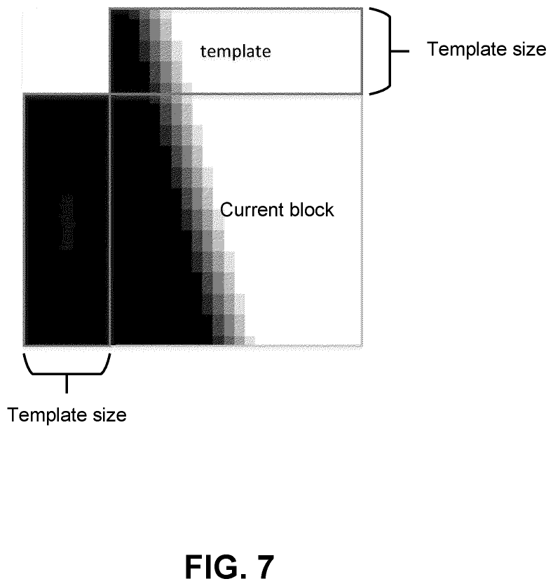

FIG. 7 illustrates an example SGPM template. The SGPM candidate list may be reordered based on the SGPM template. For example, the sum of absolute differences (SAD) between the prediction and reconstruction of the template may be used for ordering. In some examples, the template size may be one.

For a partition mode (e.g., each partition mode), an intra prediction mode (IPM) list may be derived. The IPM list may include a TIMD-derived mode, horizontal mode, and/or vertical mode. In some examples, the IPM list size may be set to a predetermined number (e.g., three). In the list, a TIMD-derived mode may be replaced by one or more (e.g., two) derived modes with horizontal and vertical orientations.

The SGPM mode may be applied with a restricted block size (e.g., 4≤width≤64 and 4≤height≤64, where width<height*8, height<width*8, and width*height≥32.

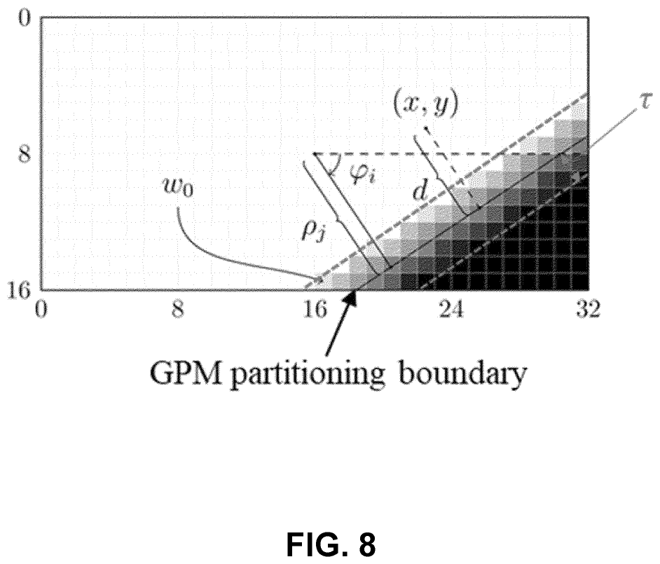

FIG. 8 illustrates an example of GPM blending. Adaptive blending may be used for SGPM. A blending depth τ (e.g., illustrated in FIG. 8) may be derived as follows:
If min (width, height)==4, 1/2 τ may be selected
else if min (width, height)==8, τ may be selected
else if min (width, height)==16, 2 τ may be selected
else if min (width, height)==32, 4 τ may be selected
else, 8 τ may be selected.

An MPM list may be constructed. In some examples, the first entry in the general MPM list may be planar mode. Intra modes of neighboring blocks and DIMD modes may be added to the MPM list. Intra modes and DIMD modes may be sorted in an ascending order based on their respective SAD cost. For example, up to 5 modes with the smallest SAD cost may be added. The SAD cost may be computed between the prediction and the reconstruction samples of the template. The sorted directional modes with an offset may be added into the general MPM list. Default modes may be added, e.g., until a general MPM list with a predetermined number of (e.g., 22) entries is constructed.

An MPM list may be divided (e.g., equally divided) into multiple groups. A group index may be parsed. A mode index may be parsed to indicate which mode in the selected group is used.

For example, mode derivation may be performed for certain types of CUs and the resulting mode) may be used for MPM generation of future CUs. Secondary MPMs may be generated based on primary MPMs, which may include angular neighbor modes and/or DIMD modes. List re-ordering may be applied, for example, based on a weight attributed based on neighbor block information. A template-based MRL (TMRL) may be derived from the same MPM list.

An MPM candidate may be determined based on a template and/or based on a score attributed based on the properties of the neighboring block. One or more candidates derived based on template(s) of neighboring block(s) of the current block may be added to the MPM list. Reordering of the MPM list may be performed based on weight(s) and/or scale(s) associated with the candidate modes in the list.

In some examples, when a candidate mode should be added in the MPM list, the candidate mode may already be present in the MPM list. A weight of this candidate mode may be updated or adjusted (e.g., to be more probable in the final MPM list) (e.g., to have a lower cost). For example, a final weight may be the sum of the weights attributed based on neighboring information. A scale may be applied to a second weight (e.g., the second weight may be reduced, e.g., halved).

DIMD neighbor mode(s) may be added to the MPM list. DIMD modes (e.g., derived DIMD modes) may be added to the MPM list, for example, before the reordering. At a (e.g., every) neighboring location where a mode is added to the MPM list, DIMD modes may be computed and added to the MPM list. In some examples, multiple modes may be added this way based on the DIMD histogram. In some examples, the number of modes added this way in the MPM list may be up to 5, which may correspond to the up to 5 modes that may be blended using DIMD. In some examples, different weights may be attributed to the derived DIMD neighbor modes, based on the histogram values of the DIMD modes. This may favor modes that are more likely to accurately predict the current CU. In some examples, the modes may be added only if the neighboring CU was predicted using DIMD.

In some examples, the DIMD process may be performed based on the template of the neighboring CU. In some examples, the DIMD process may be performed based on the reconstructed neighboring CU as the template.

TIMD neighbor modes may be added to the MPM list. TIMD modes computed on neighboring CUs may be added to the MPM list (e.g., before the reordering). At a (e.g., every) neighboring location where a mode is added to the MPM list, the TIMD modes may be computed and added to the MPM list. In some examples, multiple (e.g., several) modes may be added this way based on template cost(s) computed during the TIMD search. In some examples, the number of modes added this way in the MPM list may be up to two (e.g., which may correspond to the modes that would have been blended using TIMD). In some examples, different weights may be associated with the derived TIMD neighbor modes based on the template costs.

In some examples, the TIMD process may be performed based on the template of the neighboring CU. In some examples, the TIMD process may be performed based on the reconstructed neighboring CU as the template, and the reference samples of the reconstructed neighboring CU as predictors for the template.

In some examples, the TIMD neighbor modes may not be added to the MPM list used for the TIMD process.

SGPM neighbor modes may be added to the MPM list. In some examples, a neighboring CU may have been coded using SGPM. The intra modes used by SGPM may be added to the MPM list for the current CU. In some examples, the intra modes (e.g., both modes) may have the same weight attributed. In some examples, the weight may be scaled based on the proximity of the partition. In some examples, a scale may be applied to the weight of the intra mode(s) when adding the weight to the MPM list (e.g., the weight may be halved).

IntraTMP mode(s) may be added to the MPM list. IntraTMP may be an intra prediction mode that is based on copying a prediction block from the reconstructed area according to a template cost. IntraTMP may be considered (e.g., along with MPM reordering).

In some examples, an intraTMP mode may be added to the MPM based on one of the neighboring PU's (e.g., L, T, LR, LT, BR) being intraTMP coded. The intraTMP information for the reference PU may be used for the current PU. The block vectors derived from intraTMP may be used for the current prediction if mpm index refers to the PU with intraTMP. The use of stored information (e.g., for the reference PU) may not increase coding complexity (e.g., because the stored information may be reused for the current PU).

In some examples, intraTMP mode candidate may be added to the MPM list (e.g., consistently). IntraTMP may be constantly derived (e.g., if MPM is used), and the block vectors may be used to generate the intra prediction signal. In the case of template-based MPM reordering, the intraTMP mode may be added as a candidate, and the template distance may be a measure for intraTMP along with other intra modes. The template cost may be used to reorder the candidates as described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for video decoding, the method comprising:
determining an intra prediction mode associated with a neighboring block;
determining whether the intra prediction mode associated with the neighboring block is the same as a candidate mode on a most probable mode (MPM) list, wherein the MPM list is associated with a current block;
based on a determination that the intra prediction mode associated with the neighboring block is the same as the candidate mode on the MPM list, adjusting a weight associated with the candidate mode;
reordering the MPM list based on the adjusted weight associated with the candidate mode; and
decoding the current block based on the MPM list.

2-17. (canceled)

18. The method of claim 1, wherein the intra prediction mode associated with the neighboring block is determined based on a template-based intra mode derivation (TIMD).

19. The method of claim 18, wherein the intra prediction mode is a first intra prediction mode, the weight is a first weight, the candidate mode is a first candidate mode, and wherein the method comprises:
determining a second intra prediction mode associated with the neighboring block based on the TIMD;
obtaining a first template cost associated with the first intra prediction mode and obtaining a second template cost associated with the second intra prediction mode;
determining a second weight associated with a second candidate mode, wherein the second candidate mode corresponds to the second intra prediction mode, and wherein the first weight is determined based on the first template cost and the second weight is determined based on the second template cost;
adjusting the second weight associated with the second candidate mode; and
reordering the MPM list based on the second adjusted weight associated with the second candidate mode.

20. The method of claim 1, wherein the intra prediction mode associated with the neighboring block is determined based on a decoder side intra mode derivation (DIMD).

21. The method of claim 20, wherein the intra prediction mode is a first intra prediction mode, the weight is a first weight, the candidate mode is a first candidate mode, and wherein the method comprises:
determining a second intra prediction mode associated with the neighboring block based on the DIMD;
obtaining a first histogram value associated with the first intra prediction mode and obtaining a second histogram value associated with the second intra prediction mode;
determining a second weight associated with a second candidate mode, wherein the second candidate mode corresponds to the second intra prediction mode, and wherein the first weight is determined based on the first histogram value and the second weight is determined based on the second histogram value;
adjusting the second weight associated with the second candidate mode; and
reordering the MPM list based on the second adjusted weight associated with the second candidate mode.

22. The method of claim 1, wherein the neighboring block is a first neighboring block, the intra prediction mode is a first intra prediction mode associated with the first neighboring block, the weight is a first weight, the candidate mode is a first candidate mode, and wherein the method comprises:
determining a second intra prediction mode associated with a second neighboring block;
determining whether the second intra prediction mode associated with the second neighboring block is the same as a second candidate mode on the MPM list;
based on a determination that the second intra prediction mode associated with the second neighboring block is the same as the second candidate mode on the MPM list, adjusting a second weight associated with the second candidate mode; and
reordering the MPM list based on the second adjusted weight associated with the second candidate mode.

23. An apparatus for video decoding, the apparatus comprising:
a processor configured to:
determine an intra prediction mode associated with a neighboring block;
determine whether the intra prediction mode associated with the neighboring block is the same as a candidate mode on a most probable mode (MPM) list, wherein the MPM list is associated with a current block;
based on a determination that the intra prediction mode associated with the neighboring block is the same as the candidate mode on the MPM list, adjust a weight associated with the candidate mode;
reorder the MPM list based on the adjusted weight associated with the candidate mode; and
decode the current block based on the MPM list.

24. The apparatus of claim 23, wherein the intra prediction mode associated with the neighboring block is determined based on a template-based intra mode derivation (TIMD).

25. The apparatus of claim 24, wherein the intra prediction mode is a first intra prediction mode, the weight is a first weight, the candidate mode is a first candidate mode, and wherein the processor configured to:
determine a second intra prediction mode associated with the neighboring block based on the TIMD;
obtain a first template cost associated with the first intra prediction mode and obtaining a second template cost associated with the second intra prediction mode;
determine a second weight associated with a second candidate mode, wherein the second candidate mode corresponds to the second intra prediction mode, and wherein the first weight is determined based on the first template cost and the second weight is determined based on the second template cost;
adjust the second weight associated with the second candidate mode; and
reorder the MPM list based on the second adjusted weight associated with the second candidate mode.

26. The apparatus of claim 23, wherein the intra prediction mode associated with the neighboring block is determined based on a decoder side intra mode derivation (DIMD).

27. The apparatus of claim 26, wherein the intra prediction mode is a first intra prediction mode, the weight is a first weight, the candidate mode is a first candidate mode, and wherein the processor configured to:
determine a second intra prediction mode associated with the neighboring block based on the DIMD;
obtain a first histogram value associated with the first intra prediction mode and obtaining a second histogram value associated with the second intra prediction mode;
determine a second weight associated with a second candidate mode, wherein the second candidate mode corresponds to the second intra prediction mode, and wherein the first weight is determined based on the first histogram value and the second weight is determined based on the second histogram value;
adjust the second weight associated with the second candidate mode; and
reorder the MPM list based on the second adjusted weight associated with the second candidate mode.

28. The apparatus of claim 23, wherein the neighboring block is a first neighboring block, the intra prediction mode is a first intra prediction mode associated with the first neighboring block, the weight is a first weight, the candidate mode is a first candidate mode, and wherein the processor is configured to:
determine a second intra prediction mode associated with a second neighboring block;
determine whether the second intra prediction mode associated with the second neighboring block is the same as a second candidate mode on the MPM list;
based on a determination that the second intra prediction mode associated with the second neighboring block is the same as the second candidate mode on the MPM list, adjust a second weight associated with the second candidate mode; and
reorder the MPM list based on the second adjusted weight associated with the second candidate mode.

29. A method video encoding, the method comprising:
determining an intra prediction mode associated with a neighboring block;
determining whether the intra prediction mode associated with the neighboring block is the same as a candidate mode on a most probable mode (MPM) list, wherein the MPM list is associated with a current block;
based on a determination that the intra prediction mode associated with the neighboring block is the same as the candidate mode on the MPM list, adjusting a weight associated with the candidate mode;
reordering the MPM list based on the adjusted weight associated with the candidate mode; and
encoding the current block based on the MPM list.

30. The method of claim 29, wherein the intra prediction mode associated with the neighboring block is determined based on a template-based intra mode derivation (TIMD).

31. The method of claim 30, wherein the intra prediction mode is a first intra prediction mode, the weight is a first weight, the candidate mode is a first candidate mode, and wherein the method comprises:
determining a second intra prediction mode associated with the neighboring block based on the TIMD;
obtaining a first template cost associated with the first intra prediction mode and obtaining a second template cost associated with the second intra prediction mode;
determining a second weight associated with a second candidate mode, wherein the second candidate mode corresponds to the second intra prediction mode, and wherein the first weight is determined based on the first template cost and the second weight is determined based on the second template cost;
adjusting the second weight associated with the second candidate mode; and
reordering the MPM list based on the second adjusted weight associated with the second candidate mode.

32. The method of claim 29, wherein the intra prediction mode associated with the neighboring block is determined based on a decoder side intra mode derivation (DIMD).

33. The method of claim 32, wherein the intra prediction mode is a first intra prediction mode, the weight is a first weight, the candidate mode is a first candidate mode, and wherein the method comprises:
determining a second intra prediction mode associated with the neighboring block based on the DIMD;
obtaining a first histogram value associated with the first intra prediction mode and obtaining a second histogram value associated with the second intra prediction mode;
determining a second weight associated with a second candidate mode, wherein the second candidate mode corresponds to the second intra prediction mode, and wherein the first weight is determined based on the first histogram value and the second weight is determined based on the second histogram value;
adjusting the second weight associated with the second candidate mode; and
reordering the MPM list based on the second adjusted weight associated with the second candidate mode.

34. The method of claim 29, wherein the neighboring block is a first neighboring block, the intra prediction mode is a first intra prediction mode associated with the first neighboring block, the weight is a first weight, the candidate mode is a first candidate mode, and wherein the method comprises:
determining a second intra prediction mode associated with a second neighboring block;
determining whether the second intra prediction mode associated with the second neighboring block is the same as a second candidate mode on the MPM list;
based on a determination that the second intra prediction mode associated with the second neighboring block is the same as the second candidate mode on the MPM list, adjusting a second weight associated with the second candidate mode; and
reordering the MPM list based on the second adjusted weight associated with the second candidate mode.
